(19) United States
(12) Patent Application Publication
(10) Pub. No.: US 2003/0006655 A1
(43) Pub. Date: Jan. 9, 2003

(54) Heat dispersion, heat dissipation and thermal indication for wheel set assembly

(76) Inventor: Ming (Jason) Zhang, Montreal (CA)

Correspondence Address: Ming (Jason) Zhang, 5270 Rosedale Avenue, Montreal, QC, H4V 2H6, CA

(21) Appl. No.: 10/141,381

(22) Filed: May 8, 2002

Related U.S. Application Data
(60) Provisional application No. 60/289,997, filed on May 10, 2001.

(51) Int. Cl. H02K 9/00

(52) U.S. Cl. 310/52

(57) ABSTRACT

The present invention provides methods for

(1) first of all, rapid heat dispersion and precise thermal indication of shaft/shaft bearing assembly used in railway wheel set assemblies when bearing temperature is below a critical value;

(2) then self-initiated intensive heat dissipation once the bearing temperature is over the critical value.

The methods comprise:

(1) assembling a vehicle wheel set by mounting bearings and wheels on a railway shaft or axle with interference fit and mounting bearing adapter onto bearings;

(2) embedding heat pipe or other highly thermal conductive elements within the said vehicle wheel set;

(3) having the heat pipe only in thermal engagement within the confine of bearing, section of the axle or bearing adapter adjacent to the bearing when bearing temperature is below a critical value;

(4) having, beyond the aforesaid thermally engaged surface area, another substantially large surface area of the heat pipe that is in poor if not non thermal engagement with the shaft/shaft bearing assembly when bearing temperature is below certain critical value, and embedding, within the railway vehicles, at least one reservoir of low-melting-temperature fusible metal that transforms from solid to liquid phase and flows into the originally poorly engaged interfaces by capillary force once the bearing temperature is over the critical value;

(5) effecting rapid heat dispersion and prompt thermal indication at relatively low temperature therefore improving operational safety and visibility toward the available bearing failure detection means, and self-initiating additional intensive heat dissipation for retarding the progress of heat related bearing failure process once the temperature reaches to a critical value at which the lubricant or grease within the bearing starts to evaporate or ceases to be effective.

### 1. CROSS REFERENCE TO RELATED APPLICATIONS

This application claims the benefit of U.S. Provisional Application No. 60/289,997, filed May 10, 2001, which is hereby incorporated by reference in its entirety.

### 2. TECHNICAL FIELD

The present invention relates generally to heat dispersion, heat dissipation and thermal indication methods and apparatus to facilitate precise detection of failed bearings and to prevent catastrophic failures of railway wheel set assemblies. In particular, the present invention relates to method and apparatus for controlled heat dispersion and emergency heat dissipation with heat pipes and fusible metals embedded within vehicle wheel set assemblies.

### 3. BACKGROUND OF THE INVENTION

Overheated bearing on railroad vehicles is the end-result of mechanical degradation of bearing components due to various reasons. Some overheated bearings have led to catastrophic failures and train derailments costing the North American railroads millions of dollars each year.

Among various methods proposed for timely detection of troubled bearings in order to replace them, wayside hot bearing detection systems using infrared sensors are representative of the state of the art and presently applied in high traffic areas.

Despite all the technical advancements of wayside hot box detecting system, the occurrence of bearing burnoff related derailment remains at a constant rate over the past several years for freight cars and in the mean time costs are escalating for false alarm set-off which result in unnecessary train stops. Under the circumstances that the railroad industry moves towards heavier axle loads, higher running speed, it can be foreseen that hot bearing detection will remain a critical issue for safe and efficient railway operations.

Several new bearing failure detection methods and devices using complete different approaches have been suggested, such as:

(1) wayside and on-board acoustic bearing detectors using bearing acoustic and vibration signatures to detect incipient bearing failure; (Advanced Roller Bearing Inspection Systems, G. B. Anderson et al, 12^{th} International Wheelset congress, September 1998);

(2) on-board overheated bearing detecting systems such as wax motor activated electronic indicators within hollow cap screws or fusible material and spring activated visual indicators in axle centers U.S. Pat. No. 4,119,284, Belmont, U.S. Pat. No. 4,812,826, Kaufman, et al, and U.S. Pat. No. 5,633,628, Denny, et al).

However, none of them has found high degrees of acceptance in North American railway industry due to concerns on whether they are effective to detect various types as well as different combinations of bearing defects, or whether they are reliable alternatives for long terms. And up till now, no promising economical methods have been proposed to further improve the performance of existing wayside hot bearing detection systems so that both the risks of bearing failures and the number of false alarms will be reduced simultaneously.

In view of further performance improvement, it exists three technical dilemmas associated with the present wayside hot bearing detector systems:

1. Rapid Rise of Local Temperature Inside Bearing Versus Slow Temperature Rise Within the Scan Envelopes Monitored by Hot Bearing Detectors

The major operational problem of bearing burnoff is associated with the facts that hot bearing detectors are typically spaced at 15 to 30 mile intervals, and a fast progressed burnoff that can happen in minutes may occur between the two hot bearing detectors. Two reasons account for incompetence of the wayside hot box detectors towards the detection of fast progress bearing failure.

(1) Local overheating conditions due to relatively low thermal conductivity of bearing and axle steel.

The local heat production concentrated in the mechanically overloaded zone inside axle/bearing assembly significantly accelerates the bearing and axle failure process. In most of the failed bearings, the high temperature locations are close to the interfaces between the bores of the bearing cones and the portion of the axle under the bearing cones. Therefore, the bearing failure process depends not only on the overall heat buildup rate, but also on the local distribution of the accumulated heat within the axle and bearing assembly.

(2) Slow response in terms of temperature increase in the scan envelopes The temperature monitored by hot bearing detectors is only an indication of the amount of the heat transferred to the scan envelopes located at outer periphery of the bearing assembly. In the case when the heat input is extremely concentrated, temperatures in the scan envelopes may be well below the preset alarm triggering limit while the bearing components are already under severe local overheating conditions. One possible solution would be lowering the alarm triggering limit, however, if overdone, other thermal noises generated by other heat sources may lead to false alarms.

2. Mixed Population of Different Classes of Bearing Versus Fixed Scan Envelope For Hot Bearing Detector

Most of the existing wayside hot bearing detectors are fixed head type and are designed to monitor different classes of outboard bearings either at inboard or outboard end of bearing assembly. They are not capable to monitor, with sufficient precision, the inboard bearings used on passenger cars or mass transit cars that may share rail tracks with freight cars.

Another important technical issue for the bearing manufactures is about the conformance of the newly introduced shorter bearing/axle assemblies to the fixed hot bearing detection scan envelopes. The proposed shorter axle/bearing assemblies such as AAR Class K, Class L, and Class M represent major advancements in the axle/bearing design. They significantly improve the axle rigidity and reduce the tendency of developing fretting wear. However, the shorter bearings may have their ends located outside the scan envelopes specified for the existing hot box detectors, therefore they may experience some difficulties to conform to the present AAR scan envelope specification.

3. Rapid Heat Dissipation And Prompt Thermal Indication

A large efficient cooling device that can dissipate all the extra heat generated in the bearing failure process would be a solution to completely prevent catastrophic derailment related to bearing failure. However, because of the exponential nature of the heat input rate during bearing failure process, it is physically and economically impossible to implement any big enough cooling device that is capable of dissipating huge amount of heat within a short time. Furthermore, any cooling devices that constantly removes heat from the axle/bearing assembly can effectively delay the detection of failed bearings in its incipient failure stage to a later much dangerous thermal runaway stage where the bearing deteriorate at much faster pace. Accordingly, what are needed in the art are methods and apparatus to

(1) Retard the progress of bearing failure during its incipient failure stage without jeopardizing its visibility toward all the existing wayside hot bearing detectors;

(2) Retard the progress of bearing failure during thermal runaway stage without installing costly, voluminous cooling devices;

(3) Enable timely and precise indication of the thermal status inside different types of bearing assemblies by the temperatures within the fixed scan envelopes specified for the existing wayside hot bearing detectors.

### 4. SUMMARY OF THE INVENTION

One object of the present invention is to provide a method and apparatus for controlled yet rapid heat dispersion within the bearing/axle assembly. The heat dispersion will reduce the local heat concentration hence slow down the bearing failure process. Meanwhile it will result in more uniform heating to the bearing assembly, more efficient heat transfer from the overheated zone to both inboard and outboard scan envelopes, and more rapid temperature increases in both inboard and outboard scan envelopes for the hot bearing detectors.

Another object of the present invention is to provide a method and apparatus for self-initiated heat dissipation using existing components of wheel set assembly and/or additional compact cooling devices as heat sinks once the overall temperature of the axle/bearing assembly is over certain limit.

Another object of the present invention is to provide a method and apparatus that is able to bring timely and precise indication of the thermal status inside different types of bearing assemblies to the fixed scan envelopes specified for all the common types of wayside hot bearing detectors.

These objects of the present invention can be accomplished by embedding heat pipes within the vehicle wheel set assembly that allows controlled rapid heat transfer or heat dispersion within the axle/bearing assembly, and by embedding self-initiated interface thermal resistance converter with low melting point fusible metals that allows intensive heat dissipation to atmosphere with the help of additional forced ventilation and thermal indication devices.

Other objects and advantages of the present invention can become more apparent to those skilled in the art as the nature of the invention is better understood from the accompanying drawings, as well as detailed descriptions.

### 5. BRIEF DESCRIPTION OF THE DRAWINGS

FIG. 1 is a sectional cut away view of one embodiment of heat distributor of the present invention in which a heat pipe is embedded within a solid axle of an outboard-bearing type wheel set assembly, the said heat pipe being placed axially under bearing cones.

FIG. 1A is an end view of the apparatus depicted in FIG. 1 taken along line 1A-1A.

FIG. 1B is an enlarged sectional view showing the essential elements of the apparatus depicted in FIG. 1.

FIG. 2 is a sectional view of one embodiment of combined heat distributor/heat dissipater of the present invention in which a heat pipe is embedded within a solid axle of a wheel set and has a compact ventilator installed at the end of the heat pipe together with low-melting-point fusible metal.

FIG. 2A is an end view of the apparatus depicted in FIG. 2 taken along line 2A-2A.

FIG. 2B is a series of side views of the essential elements of the apparatus depicted in FIG. 2A, illustrating the construction of the said apparatus.

FIG. 3 is a sectional cut away view of one embodiment of combined heat indicator/heat distributor/heat dissipater of the present invention in which a heat pipe is embedded within a hollow-axle of an inboard-bearing type wheel set, with one end of the heat pipe located axially under the bearing cones and another ends stretching out of the said hollow-axle, connecting to a heat emission ring positioned within the fixed scan envelope specified for wayside hot bearing detectors.

FIG. 3A is an end view of the apparatus depicted in FIG. 3 taken along line 3A-3A.

FIG. 3B is a series of end views of the essential elements of the apparatus depicted in FIG. 3A, illustrating the structure and assembly sequence of the said apparatus.

### 6. DETAILED DESCRIPTION OF THE DRAWINGS

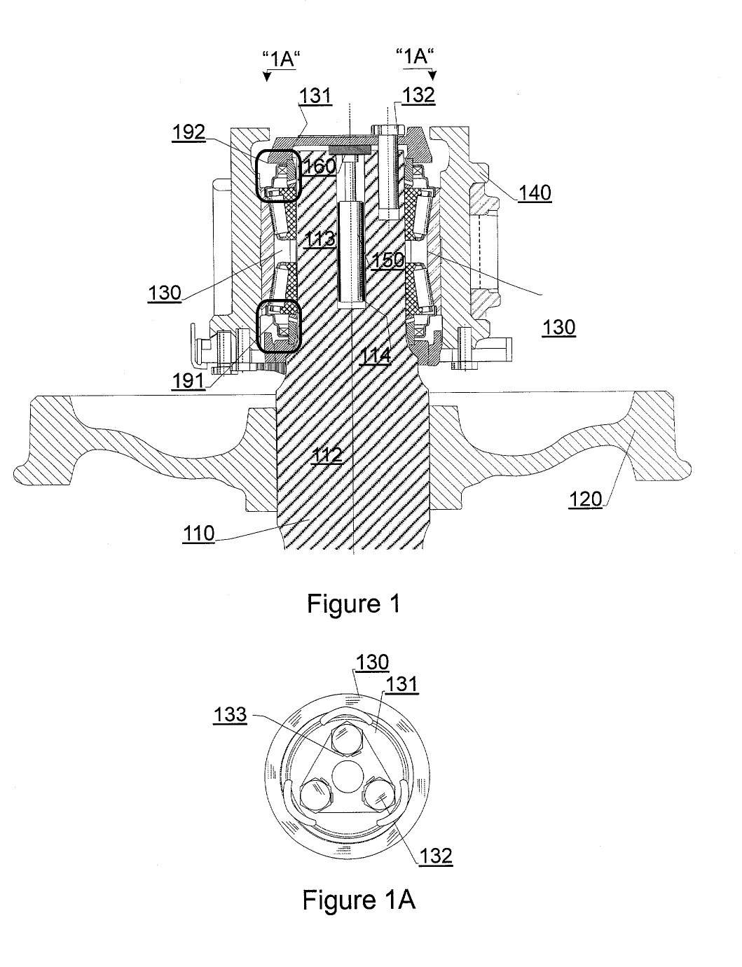

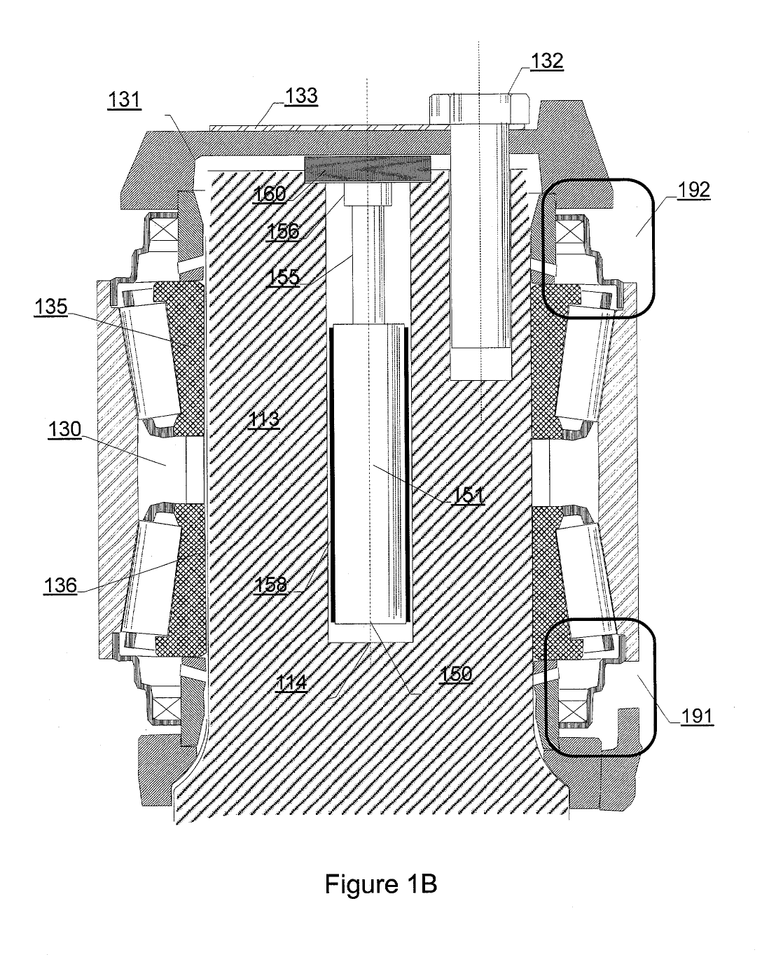

Referring to FIG. 1, half of a vehicle wheel set assembly is provided including a solid axle 110, a curved plate wheel 120, an outboard tapered roller bearing assembly 130 and a roller bearing adapter 140.

The wheel 120 is mounted and secured on the axle 110 with interference fit. The bearing assembly 130 is mounted with interference fit and retained by an end cap 131 bolted to the end of the axle 110. The roller bearing adapter 140 is slid onto the roller bearing 130 for positioning the bearings 130 within the pedestal opening of railcar side frames. The outboard bearing refers to the outer position of the bearing assembly 130 on the axle 110 relative to the wheel 120.

The section of the axle 110 under the wheel 120 is referred as axle wheel seat and indicated by number 112. The section of the said axle 110 under the bearing assembly 130 is referred as axle journal and indicated by number 113.

The axle 110 of the present invention has an aperture 114 created along the axis of the axle journal 113. After having the bearing assembly 130 mounted on the axle journal 113, a heat distributor, essentially a heat pipe assembly 150, is slide-fitted or force-fitted (press fit or shrink fit) into the said aperture 114, together with heat transfer agent such as heat transfer oil or fusible metal.

As best shown in FIG. 1B, the said heat distributor 150 consists of a heat pipe 151, an extension bar 155 and a pulling head 156. The above elements of the heat pipe assembly 150 are interconnected by a conventional method. The heat pipe 151 is positioned axially between the outer cone 135 and the inner cone 136 of the bearing assembly 130.

A thermal grease or low-melting-point metal surrounds the outer periphery 158 of the heat pipe 151 that is in close contact with the axle journal 113 to reduce the thermal contact resistance. After placing a sealing gasket 160 into the counter bore at the end of axle 110, the axle end cap 131 is mounted to the axle 110 and secured by three conventional cap screws 132. The gasket 160 made of resilient material seals the bore 114 by virtue of the pressure built up within the gasket 160 during the engagement of the axle end cap 131 to the end of the axle 110. The axle/bearing assembly is further secured by a locking plate 133. The end view of the bearing 130, the axle end cap 131, the cap screws 132 and the locking plate 133 are shown in FIG. 1A.

The heat pipe 151 has an exterior metal shell forming a gas-tight container in which it contains a small amount of vaporizable fluid. The heat distributor, namely a heat pipe assembly 150, is made of any suitable thermal conductive material including but not limited to, copper, copper alloy, aluminum or aluminum alloys, stainless steel etc.

It should be noted that the extension bar 155 and pulling head 156 can be made of the same material as shell of the heat pipe 151 or other different material with relatively low thermal conductivity. The sealing gasket 160 can be made of any suitable heat resistant, resilient material with low thermal conductivity including but not limited to silicone sponge rubber, fiberglass etc.

A pressure relief device or pressure actuating device such as a pressure relief valve, a rupture disk device, a breaking/shear pin device or a fusible plug devices may be integrated into the heat pipe assembly 151 to assure maximum safety for train operation and for on-site field inspection in view of any unexpected overheating conditions.

In operation, the heat is produced locally in a small overloaded or damaged zone inside the failed bearing assembly 130. A portion of the said heat is transferred through the axle journal 113 to the heat pipe 151 located along the axis of the axle journal 113. The section of the heat pipe 151 more adjacent to the overloaded/damaged zone receives much more heating and has higher temperature than the rest of the heat pipe. It serves as a heat sink in which the fluid vaporizes inside this high temperature section of the heat pipe. The vapor generated in the high temperature section of the heat pipe then flows towards the rest of the heat pipe where the temperatures are lower and the vapor of the fluid condenses transferring the heat rapidly to the rest of the cooler section of the axle/bearing assembly far away from the overloaded/damaged zone. Consequently, the heat pipe 151 disperses rapidly the intensive local heat within the whole axle/bearing assembly resulting in a more uniform temperature distribution inside the said axle/bearing assembly. The lubricant and the bearing components in the overloaded/damaged zone are now under much less overheated conditions and the local degradations of lubricant and the bearing components are effectively retarded and mitigated. Meanwhile the sections of the bearing located in the scan envelopes 191 and 192 for inboard and outboard wayside hot bearing detectors are heated more equally and more rapidly since the heat pipe 151 enables rapid remote heat transfer to both inboard scan envelope 191 and outboard scan envelope 192 located at the ends of the bearing. Consequently, the installed heat distributor 150 enables more precise and more prompt thermal detection for either inboard or outboard type of wayside hot bearing detectors.

The disposition of the extension bar 155 and the pulling head 156 is aimed at facilitating the assembly and disassembly of the entire heat pipe assembly 150. Due to low thermal conductivity, only small amount of heat is transferred through the extension bar 155 and the pulling head 156.

While the aforesaid embodiment of a heat distributor is described with a heat pipe assembly embedded within an axle along its axis, it is to be understood that the present invention is also applicable for uses with other alternative heat pipe implementation methods such as creating a single or a plurality of apertures at different locations in the wheel set assembly for installation of heat pipe assemblies, forming heat pipes directly with the apertures by sealing it from the outside instead of inserting a separate stand-alone heat pipe unit in the apertures.

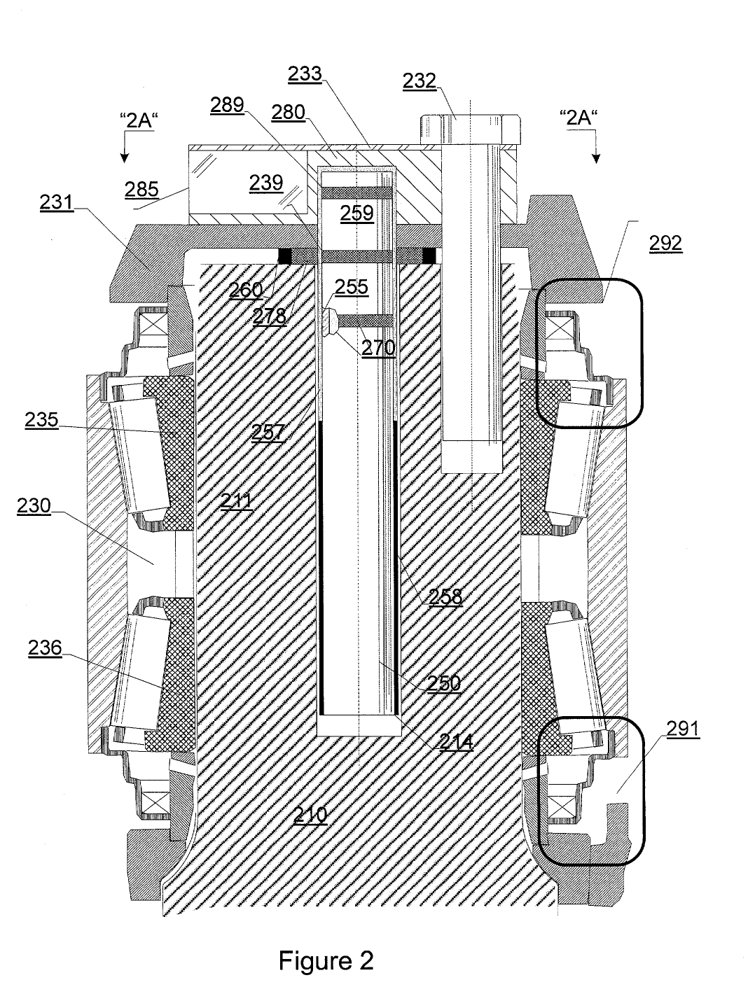

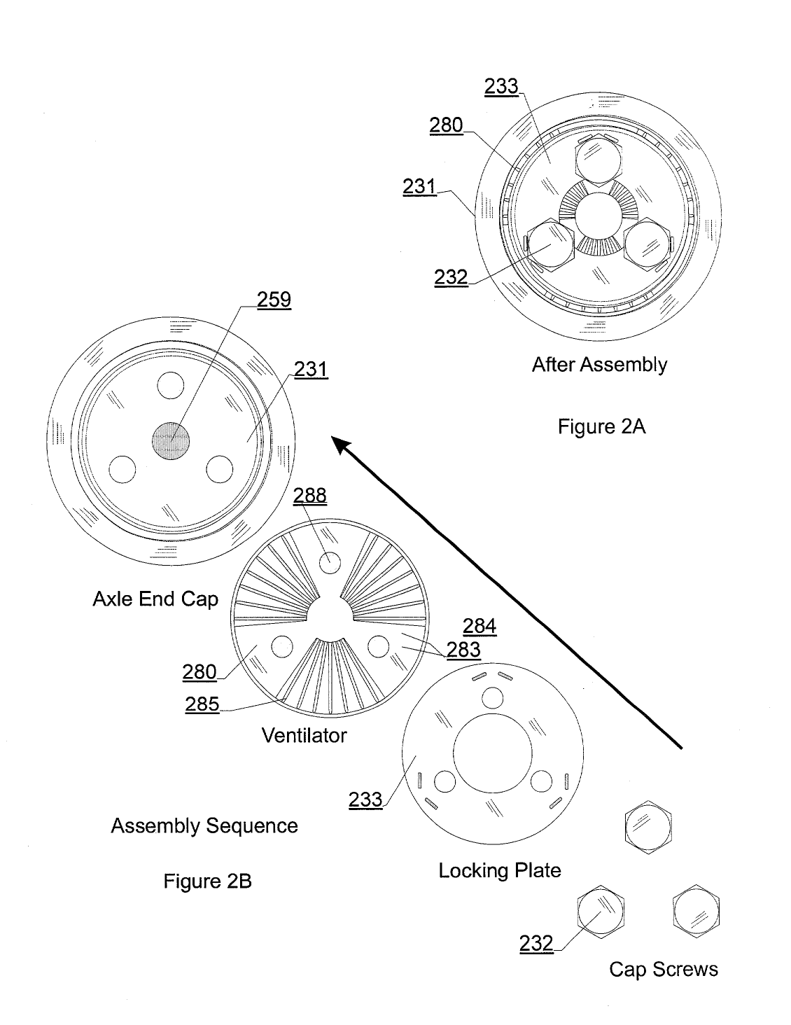

Referring to FIG. 2, a combined heat distributor and a self-initiated heat dissipater 250, essentially a heat pipe, is provided to a bearing assembly 230.

After having bearing assembly 230 mounted to the said axle journal 211, the heat pipe 250 is slide-fitted, or press-fitted, or shrink fitted into an aperture 214 created along the axis of the axle journal 211. The outer end 259 of the heat pipe 250 stretches out of the end of the axle 210. An axle end cap 231 and a centrifugal ventilator 280, with aperture 239 and aperture 259 created at their centers, are mounted to the end of the axle 210 with the help of screw bolt means 232.

The portion of the heat pipe shell 258, located axially between the two bearing cones 235 and 236, is in full thermal engagement with the bore 214. The rest of the shell 257 of the heat pipe 250 is either in loose/incomplete contact or without any direct contact with the axle journal 211, axle end cap 231 or the ventilator 280. For example, the shell section 257 may have a rough surface finish in form of deep threaded surface, or have its surface wrapped by a screen mesh made of a heat insulation material.

A plurality of grooves 255 is created on the surface of the heat pipe shell 257 and is filled by low-melting-point fusible metal. Another annular element 278 made in low-melting-point fusible metal may be placed between the axle end cap 231 and the end of the axle 210 and be surrounded by an annular sealing element 260 made of a conventional resilient material.

Referring to FIG. 2, FIG. 2A and FIG. 2B, a compact disc-shaped centrifugal ventilator 280 is mounted to the axle 210 outside the axle end cap 231. The ventilator 280 is consisted of essentially a circular disc with three recessed areas 284 where a plurality of radially extended vanes 285 is formed by a conventional method. In the protruding area 283 of the disc 280, three apertures 288 are created for mounting the cap screws 232. Another aperture 281 is created in the back of the ventilator 280, halfway through the center of the protruding section 283 for fitting on the end 259 of the heat pipe 250. The axle end cap 231, the ventilator 280 and the locking plate 233 are mounted together to the axle by the cap screws 232 and further secured by engaging the locking plate 233 around each cap screw 232. The ventilator 280 can be made by any combination of the conventional methods such as extrusion, casting, forging, welding or machining.

The cyclic shaped locking plate 233 included in the present embodiment provides dual functions: (1) it serves to lock the cap screws 232 in position once the screws are tightened, and (2) it severs as a shroud for the ventilator 280 that operates essentially as a centrifugal fan as axle rotates. A sealing gasket made in resilient material may be added between the ventilator 280 and the locking plate 233 to further improve the performance of the ventilator 280.

A pressure relief device or pressure actuating device such as a pressure relief valve, a rupture disk device, a breaking/shear pin device or a fusible plug devices may be integrated into the heat pipe 250 to assure maximum safety for train operation and for on-site field inspection in view of any unexpected overheating conditions.

The heat pipe 250 has an exterior metal shell forming a gas-tight container in which it contains a small amount of vaporizable fluid. The heat pipe assembly 250 as well as the said ventilator 280 is made of any suitable thermal conductive material including but not limited to, copper, copper alloy, aluminum or aluminum alloys, stainless steel etc.

The low-melting-point fusible metal can be made of any suitable pure metal or eutectic alloys characterized by their melting points ranging from 100 F. to 400 F. including but not limited to Indium, Tin-Lead solders, Wood's metal, 117 alloy, 198 alloy, 217 alloy, 266 alloy, 293 alloy, Sn—Zn eutectic etc.

At a relatively low temperature, only the section 258 of the shell of the heat pipe 250, located axially between outboard bearing cone 235 and inboard bearing cone 236, is in good thermal contact with the axle journal 211. The rest of the heat pipe shell 257 is either in poor thermal contact or in no contact with neither the axle/bearing assembly, nor the ventilator 280. Therefore, the heat pipe 250 functions essentially as a heat distributor to disperse the concentrated local heat to the whole axle/bearing assembly, just as the heat pipe assembly 150 does in the previous embodiment shown in FIG. 1.

However, once the temperatures at the end 259 of the heat pipe 250 and at the end of the axle 211 reaches certain preset critical value which indicates clearly a failed bearing in its thermal runaway stage, the selected fusible metal in the grooves 255 and within the ring 278 starts to melt and turn into liquid phase. The said liquid phase fusible metal is drawn by the capillary forces into the interfaces between the heat pipe shell 257 and the axle journal 211, between the heat pipe shell 257 and the axle end cap 231 and between the heat pipe shell 257 and the ventilator 280. The penetration of the liquid metal into those interfaces dramatically reduces the thermal resistances across the said interfaces, enabling rapid heat transfer from the heat pipe 250 to the end of the axle 210, the axle end cap 231 and the ventilator 280, creating a much larger effective condensation area for the vapor inside the heat pipe 250, initiating additional cooling to the axle/bearing assembly through forced ventilation generated by the ventilator 280 which rotates together with the axle 210. The progress of the bearing failure is further retarded and mitigated in the thermal runaway stage. Meanwhile the wayside hot bearing detection is kept intact by virtue of the fact that despite the additional heat dissipation/heat dispersion, the extremely large amount of heat accumulated in the axle/bearing assembly at this stage is enough to keep the temperature in the scan envelope 291 and 292 above the alarm triggering limit.

While the aforesaid embodiment of the present invention is described with a compact disc-like ventilator attached to the end of the axle, it is to be understood that the present invention is also applicable for uses with none or other types of auxiliary air or liquid cooling devices that may be integrated into the wheel set assembly or other components of the vehicle.

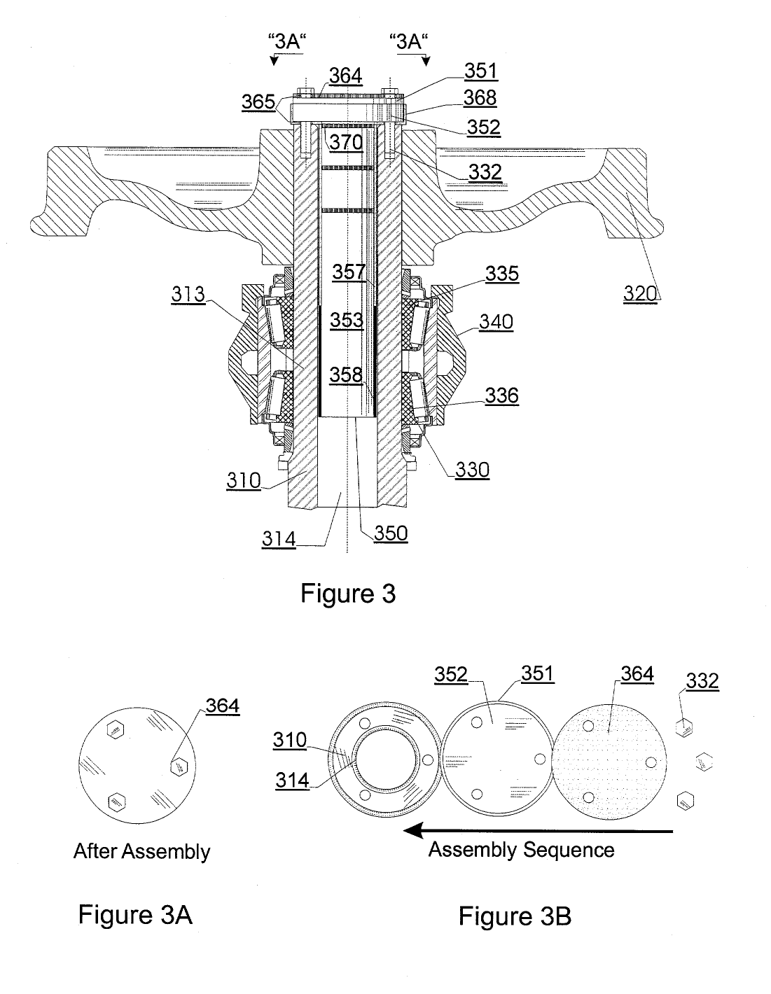

Referring to FIG. 3, half of a wheel set assembly including a hollow axle 310, a curved wheel 320, an inboard tapered roller bearing assembly 330 and a roller bearing adapter 340 is provided. The section of the said axle 310 under the bearing assembly 330 is referred as axle journal and indicated by number 313. The axle bore along the axis of the said axle 310 is indicated by number 314. The inboard bearing refers to the inner position of the bearing assembly 330 on the axle 310 relative to the wheel 320. Wheel set assemblies with inboard bearings configuration are used widely in passenger and mass transit car equipment.

In the present embodiment, a heat pipe assembly 350 functioning as a combined heat indicator/heat distributor/heat dissipater is provide to the said wheel set assembly. The said heat pipe assembly 350 comprises a heat pipe 353, a flange element 352 and a heat emission ring 351 that are interconnected to each other by a conventional means such as welding.

The section 358 of the shell of the heat pipe 353 located axially between the bearing cone 335 and the cone 336 is in full engagement with the axle journal 313. The rest of the shell 357 of the heat pipe 353 is either in loose/incomplete contact or without any direct contact with the hollow axle 310. The shell section 357 of the said heat pipe 353 may have a rough surface finish in form of deep threaded surface finish, or have its surface wrapped by a screen mesh made from heat insulation material.

A plurality of grooves 370 is created at the outer end 359 of the heat pipe 353 and is filled with low-melting-point fusible metal.

A heat emission ring 351 made of bearing steel is attached in a conventional manner to the outer periphery of the flange 352 that is connected to the end of the heat pipe 353. The ring 351 is in full thermal engagement with the flange 352 of the heat pipe assembly 350 and locates within the inboard or outboard scan envelopes for the wayside hot box detectors. A cover disc 364 and a cover sleeve 368, both being made of heat insulation material, are attached to the exterior surfaces of the flange 352 in a conventional manner, leaving only the peripheral surface of the heat emission ring 351 exposed to the atmosphere.

The said heat pipe 350 assembly is slide fitted, or press fitted, or shrink fitted into the hollow axle 310, taking advantage of the existing bore 314 along the axis of the hollow axle 310 and is locked with the axle 310 by a plurality of cap screws 332 that bolt the flange 352 of the heat pipe assembly 350 to the end of the axle 310. A plurality of non heat conductive spacers 365 is mounted together with the cap screws 332 through the flange 352 to avoid any direct thermal contact between the flange 352 and the axle 310.

A pressure relief device or pressure actuating device such as a pressure relief valve, a rupture disk device, a breaking/shear pin device or a fusible plug devices may be integrated into the heat pipe assembly 350 to assure maximum safety for train operation and for on-site field inspection in view of any unexpected overheating conditions.

The construction principle of the heat pipe 353 is the same as the heat pipe 250 depicted in FIG. 2. The additional flange member 352 of the heat pipe assembly 350 is made of any suitable thermal conductive material including, but not limited to, copper, copper alloy, aluminum and aluminum alloys. The heat emission ring 351 is made of carbon steel including but not limited to SAE 8617, SAE 8620, and SAE 52100. The low-melting-point fusible metal that occupies the grooves 370 is made of any suitable pure metal or eutectic alloys characterized by their melting points ranging from 100 F. to 400 F. including but not limited to Indium, Tin-Lead solders, Wood's metal, 117 alloy, 198 alloy, 217 alloy, 266 alloy, 293 alloy, Sn—Zn eutectic etc.

At a relatively low temperature, only the section 358 of the heat pipe shell, located axially between outboard bearing cone 335 and inboard bearing cone 336, is in good thermal contact with the axle 310. The rest of the heat pipe shell 357 is an adiabatic zone either in poor thermal contact or in no contact with the axle/bearing assembly. The only heat dissipation area left for the whole heat pipe assembly 350 is the narrow circumferential exterior surface of the heat emission ring 351.

Due to large heat transport capacity of the heat pipe 353, the temperatures of the heat input area 358 of the heat pipe 353 under the bearing cones 335 and 336, and the temperature of the heat output area at outer end 359 of the heat pipe 353 connected to the flange 352 equalize rapidly with little temperature differential. The radial temperature gradient across the flange 352 between the shell of the heat pipe 353 and the outer peripheral surface of the heat emission ring 351 located within the scan envelope of wayside hot bearing detectors is also small by virtue of the fact that the flange 352 is made of highly thermal conductive material with relatively a small thermal mass, and only a small amount of heat can be radiated from the small peripheral surface of the heat emission ring 351. As a result, a limited temperature differential exists between the axle bore 314 under the bearing cones and the temperature on the exterior surface of the heat emission ring 351 and it enables prompt and precise indication of the thermal status inside the bearing assembly by the surface temperature of the heat emission ring 351. Furthermore, the fact that the heat emission ring 352 has similar if not identical material composition and surface finish to the bearing cup or backing ring assures the same surface emissivity and the same level of detectability towards the existing wayside hot box detectors. Therefore, by sensing the temperature on the surface of the heat emission ring 351 located within the fixed scan envelope, the wayside hot box detector can determine precisely the thermal status inside the bearing assembly 330.

Once the temperature of the bearing 330 and the temperature of the heat pipe 350 reaches certain preset critical values, indicating clearly a failed bearing in its thermal runaway stage, the selected fusible metal that occupies the grooves 370 starts to melt and change into liquid phase. The said liquid fusible metal is drawn by the capillary forces into the interfaces of the heat pipe shell 357 and the axle bore 314, forming good thermal contacts across the interface, enabling rapid heat transfer from the heat pipe 350 to the axle wheel seat 312 and the wheel 320, creating a large condensation area for the vapor inside the section of the heat pipe 353 under the wheel 320, and initiating an extra heat dispersion to and heat dissipation from the wheel 320. The progress of the bearing failure is retarded and mitigated in the thermal runaway stage. Meanwhile the wayside hot bearing detection is kept intact by virtue of the fact that despite the additional heat dissipation/heat dispersion, the large amount of heat accumulated in the axle/bearing assembly at this stage is enough to keep the temperature in the scan envelope, namely the skin of the heat emission ring 351, above the alarm triggering limit.

While the aforesaid embodiment of a combined heat indicator/heat distributor/heat dissipater is described with an inboard-bearing, hollow-axle wheel set, it is to be understood that the present invention is also applicable for uses with other types of wheel set assemblies, for example, newly designed wheel set assemblies with shorter axle/bearing assemblies that may have their high temperature spots located outside the fixed scan envelopes for the present wayside hot bearing detectors.

### 7. Other General Remarks

1. While the present invention is initially designed for improving performance of wayside hot box detectors, it is to be understood that the present invention is also applicable for uses with other on board or wayside type of hot bearing detection systems with the benefits of precise thermal indication of interior bearing temperature, prolonged safe detection time window, and simple reliable no-moving-parts structure.

2. While the present invention is initially designed to facilitate precise detection of failed railway bearings in a railway wheel set assembly and to prevent catastrophic failures of railway wheel set assemblies, it is to be understood that the present invention is also applicable for uses with other shaft/shaft bearing assemblies in a rotating machinery with the same benefits of precise thermal indication of interior bearing temperature, prolonged safe detection time window, and simple reliable no-moving-parts structure.

3. While all the embodiments of the present invention are depicted and described with a tapered roller bearing assembly mounted on a railway car wheel set, it is to be understood that the present invention is also applicable for uses with other types of rotating machinery equipped with different types of bearing and bearing adapter assemblies.

While a few of the embodiments of the present invention have been explained, it will be readily apparent to those skilled in the art of the various modifications which can be made to the present invention without departing from the spirit and scope of this application as it is encompassed by the following claims.

What I claim as my invention is:

1. An apparatus for heat dispersion within a shaft/shaft bearing assembly in a rotating machinery or in a vehicle, the apparatus comprising at least:
(a) a shaft/shaft bearing assembly including at least one shaft, one shaft bearing mounted to the said shaft and one bearing adapter mounted on the said shaft bearing, both the shaft and the bearing adapter being at least partially in thermal engagement with the shaft;
(b) heat dissipation areas on the surfaces of the machinery or the vehicle adjacent to the shaft bearing such as the surfaces of the said shaft, shaft bearing, bearing adapter, and additional heat dissipation components mounted to the said rotating machinery or the said vehicle;
(c) highly thermal conductive element embedded in the said shaft/bearing assembly, the said highly thermal conductive element
(1) having at least one section in thermal engagement with the shaft/shaft bearing assembly, the thermally engaged section being substantially adjacent to potentially heat concentrated zones within the shaft bearing, the shaft and the bearing adapter;
(2) effecting rapid dispersion for heat concentrated in substantially small high-temperature zones in the said shaft/shaft bearing by transferring/redistributing the concentrated heat to the whole thermally engaged interfaces of the said highly thermal conductive element, resulting in flattened and slow temperature rises in the small high temperature zones and broadened and relatively accelerated temperature rises in the rest of the surrounding zones;
(3) enabling improvement in operational safety of the shaft/shaft bearing assembly and retarding progress of potential heat related failure of the shaft/shaft bearing assembly by aforesaid rapid heat dispersion.

2. The highly thermal conductive element, as recited in claim 1, is a heat pipe means
(a) having a thermal conductive exterior shell forming a gas-tight container in which it contains a small amount of vaporizable fluid;
(b) serving as a heat sink or heat spreader in which the fluid vaporizes in the section of the heat pipe adjacent to the high temperature zones and then the transformed vapor flows towards/condenses in the rest of the heat pipe where temperatures are lower, therefore transferring the heat rapidly from the high temperature zones to the rest of the cooler zones.

3. The apparatus for heat dispersion, as recited in claim 1, is further characterized by
(a) comprising thermal indication areas monitored by either detectors or sensors that are either contact or no contact type, the said thermal indication areas being substantially small parts of the said heat dissipation areas;
(b) enabling, with the help of embedded highly thermal conductive elements, prompt thermal indications of the said shaft/shaft bearing assembly by virtue of the said broadened and accelerated temperature rises in the zones surrounding the thermally engaged part of the highly thermal conductive elements that are adjacent to the said thermal indication areas and by virtue of no substantially accelerated heat loss from the large heat dissipation areas.

4. The apparatus for heat dispersion and thermal indication, as recited in claim 3, is further characterized by having a thermal indication area on surface of an additional thermal indication means, the said additional thermal indication means
(a) locating within the scan envelope or being in thermal contact with a heat detector or heat sensor and being substantially far from the shaft bearing;
(b) being in thermal engagement with highly thermal conductive element that serve as heat dispersion means for the shaft/shaft bearing assembly;
(c) receiving heat rapidly from the highly thermal conductive element and providing prompt temperature changes in the thermal indication area.

5. The additional thermal indication means, as recited in claim 4, is further characterized by
(a) being mounted to the rotating machinery or the vehicle where the shaft/shaft bearing assembly is included and is scanned by non contact heat detection means;
(b) having a core section made of highly thermal conductive material and an outer ring or a layer of coating in a material similar to the bearing or bearing housing with substantially identical heat adsorption and/or heat emission characteristics;
(c) being substantially thermal insulated from the rotating machinery or the vehicle or other surroundings except the areas scanned by the non contact heat detection means.

6. The apparatus for heat dispersion, as recited in claim 1, is further characterized in that
(a) the embedded highly thermal conductive element has, beyond the aforesaid thermally engaged surface area, another substantially large surface area that is in poor if not non thermal engagement with the shaft/shaft bearing assembly when the bearing temperature is below a critical value;
(b) a self-activated interface thermal resistance converter means is embedded within the shaft/shaft bearing assembly either in contact with or substantially adjacent to the highly thermal conductive element, and reduces substantially, once the bearing temperature reaches to the critical value, thermal resistance on the interfaces that originally, only poor if not non thermal engagement exist;
(c) a rapid internal heat dispersion is realized substantially adjacent to the heat concentrated zones within the shaft bearing, the shaft and the bearing adapter when the bearing temperature is below certain critical value, and a rapid heat dissipation is realized by virtue of rapid heat transfer across the whole length of the heat pipe and by virtue of substantial reduction of thermal contact resistance across the aforesaid interfaces once the bearing temperature reaches the said critical value.

7. The critical value of bearing temperature in claim 6 is the evaporation temperature for the bearing lubrication agent or grease contained within the shaft bearing, ranging from 150° F. to 650° F.

8. The self-activated interface thermal resistance converter, as recited in claim 6, is further characterized by
(a) comprising one or a plurality of reservoirs filled with low-melting-point fusible metal that transforms from solid phase to liquid phase above the said critical temperature;
(b) being embedded in the shaft/shaft bearing assembly and either in contact with or adjacent to the said surface area of the heat pipe means that is in poor if not non thermal engagement with the shaft/shaft bearing assembly when the bearing temperature is below the said critical temperature;
(c) releasing automatically above the critical bearing temperature the transformed liquid phase fusible metal to the interface of the section of the heat pipe in poor thermal contact with the shaft/shaft bearing assembly and reducing significantly thermal resistance on the said interface.

9. The apparatus in claim 1, wherein
(a) the bearing adapter is one of the following type: bearing pillow block, combined bearing housing and bearing mounting/support base, vehicle bearing adapter etc.;
(b) the said highly thermal conductive element is embedded in one or a combination of following locations within the said shaft/shaft bearing assembly including: aperture/bores created or existed along the shaft, enlarged cap screw holes at the end of the shaft, and aperture/bores created or existed in the bearing adapter;
(c) the additional heat dissipation components are cooling fins or ventilators built into or attached to the rotary components of the rotating machinery or the vehicle.

10. The apparatus in claim 1, wherein
(a) the shaft/shaft bearing assembly is part of a railway vehicle wheel set assembly including tapered roller bearings and wheels mounted on a railway axle with interference fits, bearing adapters mounted onto the said bearings;
(b) the said heat pipe means that is used as highly thermal conductive element, is embedded in one or a combination of following locations within the said railway vehicle wheel set assembly including: center of the solid axle, inner bore of the hollow axle, enlarged cap screw holes at the end of the axle, additional holes at the end of the axle, and holes in the bearing adapter;
(c) the said additional heat dissipation components are cooling fins or ventilators mounted at the end of the axle, on the axle end caps, or cooling fins mounted on the sides of bearing adapters.

11. The said heat pipes means, as recited in claim 10, is further characterized by
(a) being embedded in an aperture axially extended within the axle;
(b) either having a length shorter than the axial length of the railway bearing and locating under the bearing, or having an overall length substantially longer than the said railway bearing but only being thermally engaged with the section of the axle axially within the confine of the bearing.

12. The thermal indication areas, as recited in claim 3, are the scan envelopes in railway vehicle wheel set monitored by wayside hot box detectors.

13. An apparatus for rapidly dissipating heat from shaft/shaft bearing assembly in a rotating machinery or a vehicle, the apparatus comprising:
(a) a shaft/shaft bearing assembly including at least one shaft, one shaft bearing mounted to the said shaft and one bearing adapter mounted on the said shaft bearing, both the shaft and bearing adapter being at least partially in thermal engagement with the shaft;
(b) heat dissipation areas on the surfaces of the machinery or the vehicle adjacent to the shaft bearing such as the surfaces of the said shaft, shaft bearing, bearing adapter, and additional heat dissipation components mounted to the said rotating machinery or the said vehicle;
(c) highly thermal conductive element embedded in the said shaft/shaft bearing assembly, the said highly thermal conductive element transferring heat concentrated in substantially small high-temperature zones to the rest of large low temperature zones and then dissipating the heat to atmosphere from substantially large heat dissipation area.

14. The highly thermal conductive elements, as recited in claim 13, is a heat pipe means
(a) having a thermal conductive exterior shell forming a gas-tight container in which it contains a small amount of vaporizable fluid;
(b) serving as a heat sink in which the fluid vaporizes inside the high temperature section of the heat pipe and flows towards/condenses in the rest of the heat pipe where the temperatures are lower therefore transferring the heat rapidly to the rest of the cooler section of the heat pipe.

15. A method for rapidly dispersing heat from shaft/shaft bearing assemblies in a rotating machinery or a vehicle, the method comprising:
(a) assembling shaft/shaft bearing assembly by mounting shaft bearing on a shaft and then mounting bearing adapters onto the said bearings assemblies; having both the shaft and the bearing adapter in at least partially thermal engagement with the said bearing;
(b) including within heat dissipation areas that are on the surfaces of the machinery or the vehicle, substantially small thermal indication areas that are monitored by heat detector or sensors of either contact or non contact type;
(c) embedding within the said shaft/shaft bearing assembly highly thermal conductive element that
(1) has at least one section in thermal engagement with the shaft/shaft bearing assembly, the thermally engaged section being substantially adjacent to potentially heat concentrated zones within the shaft bearing, the shaft and the bearing adapter;
(2) effects rapid dispersion for heat concentrated in substantially small high-temperature zones in the said shaft/shaft bearing by transferring/redistributing the concentrated heat to the whole thermally engaged interfaces of the said highly thermal conductive element, resulting in flattened and slow temperature rises in the small high temperature zones and broadened and relatively accelerated temperature rises in rest of the surrounding zones;
(3) enables improvement in operational safety of the shaft/shaft bearing assembly and retards progress of potentially heat related shaft/shaft bearing assembly failure process by aforesaid rapid heat dispersion of the concentrated heat;
(4) enables prompt thermal indications of the said shaft/shaft bearing assembly by virtue of aforesaid rapid dispersion of concentrated heat which accelerates temperature rises in the zones surrounding the thermally engaged part of the interfaces, thus accelerating also temperature rises in the said thermal indication areas, and by virtue of no substantially accelerated heat loss from the large heat dissipation areas.

16. The highly thermal conductive element, as recited in claim 15, is a heat pipe means
(a) having a thermal conductive exterior shell forming a gas-tight container in which it contains a small amount of vaporizable fluid;
(b) serving as a heat sink in which the fluid vaporizes inside this high temperature section of the heat pipe and flows towards/condenses in the rest of the heat pipe where the temperatures are lower therefore transferring the heat rapidly to the rest of the cooler sections of the heat pipe.

17. The method for rapidly dispersing heat within a shaft/shaft bearing assembly, as recited in claim 15, is further characterized in that
(a) the embedded highly thermal conductive element has, beyond the aforesaid thermally engaged surface area, another substantially large surface area that is in poor if not non thermal engagement with the shaft/shaft bearing assembly when the bearing temperature is below a critical value;
(b) a self-activated interface thermal resistance converter means is embedded within the shaft/shaft bearing assembly either in contact with or substantially adjacent to the highly thermal conductive element, and reduces substantially, once the bearing temperature reaches to the critical value, thermal resistance on the interfaces that originally, only poor if not non thermal engagement exist;
(c) a rapid internal heat dispersion and a prompt thermal indication are realized substantially within the shaft bearing, the shaft and the bearing adapter when bearing temperature is below certain critical value, and additional rapid heat dissipation is further realized by virtue of rapid heat transfer across the whole length of the heat pipe and by virtue of substantial reduction of thermal contact resistance across the aforesaid interfaces once the bearing temperature reaches the said critical value.

18. A method for rapidly dissipating heat from shaft/shaft bearing assemblies in a rotating machinery or a vehicle, the method comprising:
(a) assembling shaft/shaft bearing assembly by mounting shaft bearing on a shaft and then mounting bearing adapters onto the said bearings assemblies; having both the shaft and the bearing adapters in at least partially thermal engagement with the said bearing;
(b) providing heat dissipation areas on the surfaces of the machinery or the vehicle including the said shaft, shaft bearing, bearing adapter, and additional heat dissipation components mounted to the said rotating machinery or the said vehicle;
(c) embedding within the said shaft/shaft bearing assembly a highly thermal conductive element that transfers heat concentrated in substantially small high-temperature zones to the rest of large low temperature zones and then dissipates the heat to atmosphere from substantially large heat dissipation area.

19. The highly thermal conductive elements, as recited in claim 18, is a heat pipe means
(a) having a thermal conductive exterior shell forming a gas-tight container in which it contains a small amount of vaporizable fluid;
(b) serving as a heat sink in which the fluid vaporizes inside this high temperature section of the heat pipe and flows towards/condenses in the rest of the heat pipe where the temperatures are lower therefore transferring the heat rapidly to the rest of the cooler section of the heat pipe.
